(19) United States
(12) Patent Application Publication
(10) Pub. No.: US 2016/0322143 A1
(43) Pub. Date: Nov. 3, 2016

(54) Cryostat for Superconducting Devices

(71) Applicant: VICTORIA LINK LIMITED, Wellington (NZ)

(72) Inventors: Michael Philip Staines, Lower Hutt (NZ); Neil David Glasson, Lower Hutt (NZ)

(21) Appl. No.: 15/104,548

(22) PCT Filed: Dec. 18, 2014
(86) PCT No.: PCT/NZ2014/050022

§ 371 Date: Jun. 15, 2016

(30) Foreign Application Priority Data
Dec. 18, 2013 (NZ) 619193

(51) Int. Cl. H01F 6/04; H01F 27/10; H01F 36/00

(52) U.S. Cl. CPC H01F 6/04; H01F 36/00; H01F 27/105

(57) ABSTRACT

A cryostat for a superconducting device comprises a tank insulated with a non-vacuum material which may be a foam insulation material, and one or more cavities extending through the tank, through HTS coils for example which are vacuum insulated by for example concentric glass sleeves, through which cores, external to the cryostat, associated with the coils pass.

### FIELD OF THE INVENTION

The invention relates to a cryostat. More particularly, the invention relates to a cryostat for use with superconducting devices including but not limited to superconducting transformers and fault current limiters.

### BACKGROUND OF THE INVENTION

AC power devices using superconductors such as superconducting transformers or fault current limiters (FCL) dissipate significant power and heat when transformers operate at, a high current or when a FCL intercepts a fault. To maintain the superconducting components at their superconducting temperatures, they are placed within a cryostat. A cryostat typically comprises a vessel which contains cryogenic coolant such as liquid nitrogen (LN2) and the superconducting components that need to be cooled are directly immersed in the cryogen bath. The superconducting components that need to be placed in a cryostat are normally the HTS or LTS coil windings.

A cryostat thermally insulates the cryogen and the coil windings from the ambient temperature. However, other components of these AC power devices such as iron cores and many realisations of FCL should still be operated at room temperature to reduce heat dissipation within the cryogenic space. Thermal insulation must be provided to isolate the iron cores due to the heat dissipated during their operation. Thus a cryostat often has a complex geometry as it only needs to partially cool a superconducting device while it also needs to isolate its contents from the heat dissipating room temperature components of such devices. In many cases the separation between the components at cryogenic temperatures and those at room temperature should be minimized. For example the clearance between superconducting windings and the core in a transformer should ideally be not more than a few centimetres for electrical and cost efficiency. This implies that the thermal insulation in this space should have low thermal conductivity compared to other parts of the cryostat where higher thermal conductivity can be tolerated because a greater insulation thickness can be accommodated. An efficient three-phase transformer should also have all phase windings sharing the same cryogenic volume to avoid heat load from electrical connections between the phase windings traversing spaces at ambient temperature, which further complicates the cryostat geometry.

The standard design of a transformer cryostat has been using a vacuum insulated glass reinforced plastic (GRP) composite vessel. The construction of such cryostat is challenging and cost-ineffective. Only one such three-phase cryostat has been demonstrated to date. Such cryostats typically require continuous pumping. Vacuum pumps add complexity and cost and require maintenance—serious drawbacks in the electrical utility environment. For superconducting transformers it is also advantageous to enlarge the cryogenic space beyond that required for windings alone to accommodate heat exchangers, an on-load tap changer, and simply to increase the LN2 volume for increased temperature stability. Fabricating large vacuum insulated vessels is difficult because the vacuum spaces need to be highly engineered to prevent collapsing under atmospheric pressure.

The Invention alms to ameliorate at least some of the problems mentioned above or at least provide an alternative cryostat for the public.

### SUMMARY OF THE INVENTION

In broad terms the invention comprises a cryostat for a superconducting device, comprising a tank for containing a cryogenic coolant and superconducting device, insulated with a first, non-vacuum thermal insulation material, and comprising at least one cavity extending through the tank insulated with a second, vacuum insulation around the cavity.

In at least some embodiments the first thermal insulation material comprises a foam insulation material such as an expanded foam insulation material.

In at least some embodiments the cavity through the tank is defined by an inner wall and an outer wall of the vacuum insulation, such as concentric sleeves, of a material such as glass for example.

In some embodiments the foam material has a thermal conductivity averaged over the temperature range 77 K to 300 K of less than about 0.03 W/mK. In some embodiments the foam insulation has a thickness of not less than about 400 mm, about 450 mm, or about 500 mm, or about 550 mm, or about 600 mm, or about 800 mm.

In some embodiments the vacuum insulation has an effective thermal conductivity of less than about 0.003 W/mK, not more than about 0.002 W/mK, or about 0.001 W/mK. In some embodiments the vacuum insulation has an average thickness of between about 5 and about 25 mm.

In the cryostat of the invention the vacuum insulation around and defining the cavities to accommodate the transformer cores is thin walled, while the outer insulation of the tank comprises thicker, lower cost non-vacuum insulation material, which thereby avoids the need to fabricate a much higher cost all-vacuum insulated vessel. Also the cryostat construction can be modular and flexible and thus again more economic to manufacture.

As used here the term “and/or” means “and” or “or”, or both.

As used herein “(s)” following a noun means the plural and/or singular forms of the noun.

The term “comprising” as used in this specification means “consisting at least in part of”. When interpreting statements in this specification which include that term, the features prefaced by that term in each statement all need to be present but other features can also be present. Related terms such as “comprise” and “comprised” are to be interpreted in the same manner.

### BRIEF DESCRIPTION OF THE FIGURES

The invention is further described with reference to the drawings which show an exemplary embodiment of a cryostat of the invention, in which:

FIG. 1 is a schematic vertical cross-section view in one plane of the cryostat with lid;

FIG. 2 is a schematic vertical cross-section view in another plane of the cryostat with lid; and

FIG. 3 is a schematic horizontal cross-section view of the cryostat along line I-I of FIG. 1.

### DETAILED DESCRIPTION OF PREFERRED EMBODIMENTS

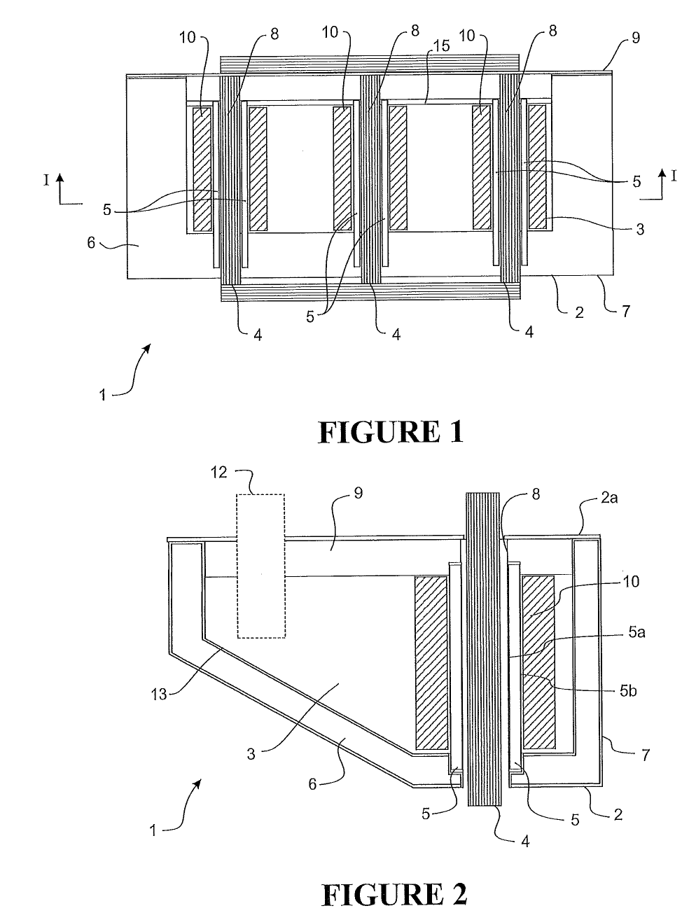

The figures show a cryostat for cooling the HTS coils of a three phase superconducting transformer. The cryostat 1 comprises a tank 7 having a strong and gas impermeable casing 2 for containing a cryogenic coolant 3 such as liquid Nitrogen, within which tank 7 are contained the superconducting transformer coils 10 which need to be maintained at a cryogenic temperature. The LTS or HTS coils 10 are preferably directly immersed in the cryogenic coolant 3. The level of the coolant in the tank is indicated by line 15 in FIG. 1. The tank includes a lid 9. The lid part of the outer casing is indicated at 2a. The cryogenic coolant 3 is maintained within a suitable temperature range by a cryo-cooler and heat exchanger 12 indicated in FIG. 2.

Lining the interior of the tank 7 including the lid 9 is a non-vacuum thermal insulation layer 6 which comprises a closed cell foam material such as an expanded closed cell polystyrene foam. In at least some embodiments the foam material has a thermal conductivity of less than 0.03 W/mK and a minimum thickness of not less than about 400 mm. In other embodiments, the foam material may have a minimum thickness of not less than about 450 mm, or about 500 mm, or about 550 mm, or about 600 mm, or about 800 mm.

In at least some embodiments the foam insulation layer 6 has a substantially uniform thickness. In at least some embodiments the foam insulation layer 6 lines substantially the entire interior of the tank 7. The foam insulation layer 6 may be attached to the casing 2, by for example thermal bonding or glueing, or may be formed by spraying or pouring within the casing.

The outer casing 2 is typically formed of a more rigid and puncture proof material than the insulation material 6, such as a glass reinforced plastics (GRP) material for example, and the thickness of the outer casing 2 is less than that of the thicker insulation layer 6. The outer casing 2 primarily provides structural strength to the tank.

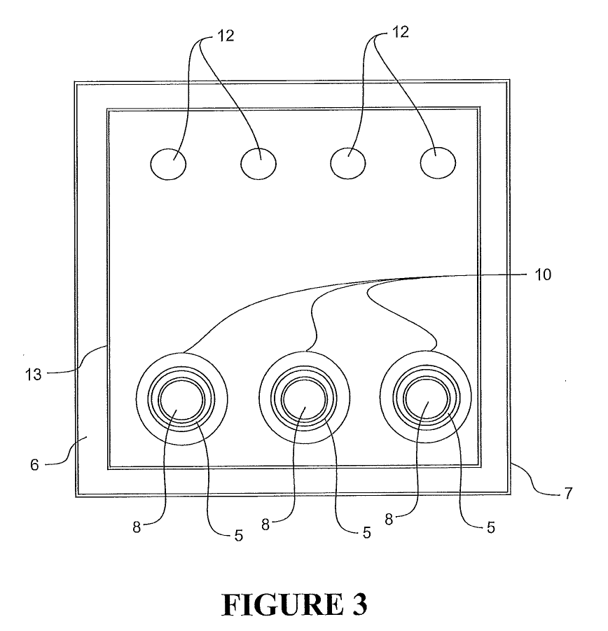

In some embodiments a stiffening agent such as fibre reinforced polymer is incorporated in the foam insulation layer 6 to provide stiffening against deformation caused by thermal contraction. In other embodiments a stiffening layer such as a layer of fibre reinforced polymer or glass reinforced polymer (GRP) composite may be provided on the inner and/or outer surfaces of the foam insulation layer 6. In the example shown a GRP layer 13 is provided on the inside surface of the foam insulation 6 see FIGS. 2 and 3 which show both the outer casing 2 and inner layer 13 (FIG. 1 does not).

The cryostat has a cavity extending through the tank extends between the tank base and a tank lid. In the embodiment shown the cryostat 1 comprises three cavities 8 which extend through the tank 7. The cavities 8 are hollow passages through the tank between top and bottom as shown. Each of the cavities 8 is defined and thermally insulated by a vacuum insulation layer formed by a vacuum sleeve 5 defined by at least an inner wall 5a and an outer wall 5b (see FIG. 3) of gas impermeable material which define a closed vacuum space in between, such as glass. Alternatively other suitable materials such as a gas impermeable composite material may also be used as inner and outer walls which define a vacuum space. In the embodiment shown each glass wall 5a and 5b comprises a glass cylinder, and the two larger and smaller diameter glass cylinders are co-axially arranged and joined/sealed at their two ends to define the closed vacuum space or vacuum sleeve. The core 4 of each transformer phase is accommodated in the cavity 8 through one of the vacuum sleeves 5.

The vacuum insulation around and defining the cavities to accommodate the transformer cores can be pre-formed in modular form and then directly installed in the tank comprising non-vacuum outer insulation. The vacuum sleeves are joined to the foam insulation 6 at their two opposite ends, and the joints are made leak tight by glue or by any other suitable means to prevent leakage of the cryogenic coolant 3 at the bottom joint, and by elastomeric sealant, O-rings, or gaskets at the top joint to form a hermetic seal.

As stated, in the embodiment shown three vacuum cylinders 5 are provided to receive a limb of the iron core 4 of a three phase transformer, but in another embodiment a single vacuum cylinder may be provided for a single coil around a cavity within the tank, with an associated core passing through the cavity. In another embodiment the coil may be of a current limiting device.

As stated the vacuum cylinders 5 are thin walled to allow close coupling between the transformer coils 10 within the cryostat and their associated external cores 4, while at the same time the use of the thicker foam insulation 10 avoids the need to fabricate a much higher cost all-vacuum insulated vessel as previously proposed. The cryostat losses can be similar to or little more than for an equivalent size all-vacuum insulated cryostat at much lower cost. The larger the cryostat the greater the economic gains which can be achieved. Also the cryostat construction can be modular and flexible and thus again more economic to manufacture.

In at least some embodiments the vacuum insulation 5 has an effective thermal conductivity of less than 0.001 W/mK and an average thickness of about 5 to 25 mm. In other embodiments, the vacuum insulation 5 may have an effective thermal conductivity of not more than about 0.002 W/mK, or about 0.003 W/mK.

In at least some embodiments the vacuum sleeves 8 also provide insulation against radiative heat transfer. In one embodiment radiative insulation may comprise aluminised mylar sheet or similar insulation systems known as multi-layer insulation (MLI) lining the interior of the vacuum space. The conductive coating mylar sheet is subdivided to nullify the effects of eddy currents induced by stray magnetic field from the core. In another embodiment, glass microspheres within the vacuum space to provide radiative insulation.

In a further embodiment the glass sleeves are silvered on the interior surfaces of the vacuum cavity with a break to avoid a conducting path encircling the cores.

The foregoing describes the invention including a preferred form thereof. It is to be understood that the cryostat can be used with other superconducting devices. Alterations and modifications as will be obvious to those skilled in the art are intended to be incorporated in the scope hereof as defined in the accompanying claims.

1. A cryostat for a superconducting device, comprising a tank for containing a cryogenic coolant and superconducting device, insulated with a first, non-vacuum thermal insulation material, and comprising at least one cavity extending through the tank insulated with a second, vacuum insulation around the cavity.

2. A cryostat according to claim 1 wherein the first thermal insulation material comprises a foam insulation material.

3. A cryostat according to claim 2 wherein the first thermal insulation material comprises an expanded foam insulation material.

4. A cryostat according to claim 1 wherein the cavity through the tank is defined by an inner wall and an outer wall of the vacuum insulation.

5. A cryostat according to claim 4 wherein the inner wall and outer wall of the vacuum insulation comprise concentric sleeves.

6. A cryostat according to claim 4 wherein the inner wall and outer wall of the vacuum insulation comprise glass walls.

7. A cryostat according to claim 1 wherein the first insulation has a thermal conductivity averaged over the temperature range 77 K to 300 K of less than about 0.03 W/mK.

8. A cryostat according to claim 1 wherein the first insulation has a thickness of not less than about 400 mm.

9. A cryostat according to claim 1 wherein the vacuum insulation has an effective thermal conductivity of less than about 0.003 W/mK.

10. A cryostat according to claim 1 wherein the vacuum insulation has an average thickness between about 5 and about 25 mm.

11. A cryostat according to claim 1 wherein the second, vacuum insulation around the cavity includes a radiative insulation layer with a break to avoid a conducting path encircling the cavity.

12. A cryostat according to claim 1 wherein the tank comprises a tank base and a tank lid.

13. A cryostat according to claim 12 wherein the cavity extending through the tank extends between the tank base and tank lid.

14. A cryostat according to claim 1 wherein the superconducting device comprises a coil around the cavity within the tank, with an associated core passing through the cavity.

15. A cryostat according to claim 1 wherein the superconducting device comprises a three phase transformer, and the cryostat comprises three said vacuum insulated cavities extending through the tank each with transformer coils around the cavity within the tank and a core for each transformer phase passing through the cavity.

16. A cryostat according to claim 1 wherein the superconducting device comprises a current limiting device.

17. A superconducting coil and cryostat comprising a tank containing the coil and a cryogenic coolant within a foam insulation, and vacuum insulated cavity through the coil.

18. A superconducting coil and cryostat according to claim 17 wherein the vacuum insulated cavity is defined by inner and outer concentric sleeves.

19. A cryostat according to claim 18 wherein the concentric sleeves comprise glass sleeves.

20. A cryostat according to claim 18 wherein one or both of the concentric sleeves includes a radiative insulation layer with a break to avoid a conducting path around the cavity.

21. A cryostat according to claim 17 wherein the tank is defined by a tank base and a tank lid and the cavity extends through the tank between the tank base and tank lid and a core associated with the coil passes through the cavity.

22. A cryostat comprising a tank of a relatively thin walled outer material lined with a relatively thicker walled inner foam insulation material, and comprising vacuum insulated cavity extending through the tank, the vacuum insulation having a thinner wall section than the thickness of the foam insulation material.
